(19) United States
(12) Patent Application Publication
(10) Pub. No.: US 2012/0055738 A1
(43) Pub. Date: Mar. 8, 2012

(54) CONSTRUCTION SAFETY HANGER

(76) Inventor: James Larkin, Scarsdale, NY (US)

(21) Appl. No.: 13/226,972

(22) Filed: Sep. 7, 2011

Related U.S. Application Data
(60) Provisional application No. 61/380,506, filed on Sep. 7, 2010.

(51) Int. Cl. F16M 13/02; B23P 11/00; A62B 35/00

(52) U.S. Cl. 182/138; 248/317; 248/339; 29/525.01

(57) ABSTRACT

A safety hanger system for attachment to horizontal members of stringers or other support members forming a subfloor include a plurality of safety hanger straps each of which is provided with closed loop ends. Rigid retaining members such as D-rings are linked through one of said loop ends at one end of each of the straps. Snap hooks are supported on the retaining members. The safety hangers are attachable in spaced relationship to the stringers with at least one snap-hook positioned to engage a safety net below the adjacent stringers to catch a worker that slips through a subfloor under which the net is placed, whereby workers have freedom of movement above the subfloor without the need to be tethered by lanyards to any given fixed point. A method is disclosed for attaching the safety hanger straps to the stringers and for securing safety net(s) to the snap hooks.

### CROSS REFERENCE TO RELATED APPLICATION

This application is related to Provisional Patent application Ser. No. 61/380,506 filed on Sep. 7, 2010.

### BACKGROUND OF THE INVENTION

1. Field of the Invention

The invention generally relates to the filed of construction and. more specifically, to a construction safety hanger.

2. Description of the Prior Art

It has always been a considerate hazard safety to workman involved in a construction industry, such as steel frames for buildings, bridges and other tall structures. Because of the serious hazards that construction workers are exposed to the Occupational Safety and Health Administration (OSHA) has enacted numerous health and safety standards and regulations. One such set of regulations involves fall protection. During the initial phases of construction, when buildings are relatively open and the walls or other protective barriers are not yet in place, workers can accidently fall with potential grave injury. OSHA had implemented regulations for work environments or “control zones” that are spaced in distance between unguarded edges of a building or structure and a line which is set back a safe distance, typically 2 m or 6.5 ft. In such environments, OSHA requires that employers provide a “fall protection system” which means any of the following when used to protect workers from a fall or to minimize the risk of falling: guard rails, a safety belt or full body harness with lanyard and/or life line and an anchor; a safety net; a control zone; a safety monitor within a controls zone; or any other procedures acceptable to OSHA.

Long before the OSHA regulations, steps were taken and efforts made to protect construction workers from falls. Thus, in U.S. Pat. No. 1,971,571 to McMullen a safety belt is disclosed designed to reduce the likelihood of personal injuries to individuals such as firemen and the like engaged in hazardous occupations involving danger from falling from high locations. The safety belt is in the nature of an auxiliary belt attached to a regulation belt of the kind usually provided to firemen and other individuals engaged in occupations requiring that the individuals work in hazardous locations, often at considerable elevations. The belt is constructed so that with minimum effort it can be secured to any suitable object, such as a post, railing or a ladder or to any other similar object to reduce to a minimum the likelihood of injury to the individual in the event that the individual should fall from his post of duty. However, such safety belt, once secured to a post, railing or ladder renders the individual relatively immobile and with a limited maneuverability.

In U.S. Pat. No. 2,303,954 to Roke a safety device for workman on steel structures is disclosed, for use by workmen involved in the erection of steel frames for buildings, bridges and the like. The device is a safety device that provides a greater degree of freedom of movement of the workmen. However, the device is primarily designed to be used with steel frame structures and is configured to engage steel beams, such as I-beams or the like. The device is also intended to avoid workmen from experiencing the full momentum of the fall and such force is moderated by cushioning devices.

In U.S. Pat. No. 5,165,499 to Bell an anchor system is disclosed for use with full prevention safety devices. The anchor system is intended for releasable securement to some portion of a building to service an anchor for personnel safety. The anchor system is arranged to be secured to a fixed member, e.g., an I-beam. An elongated strap and a releasable fastening/locking device is provided in conjunction with a ratchet-operated member to fix the strap to fixed support member. A lanyard is connected to the anchor assembly to provide a worker a degree of freedom of movement.

In Design patent Nos. D367,949 and D449,136 fall-arrest straps are disclosed that consist of a relatively short strap with a closed loop at one end and a ring captured within a closed loop on the other end of the strap. Straps of this type are marketed under the trademark SAFE-T-STRAPS™. Such safety straps are used at constructions sites and made of nylon that becomes anchored to the buildings structures. Thus, when concrete is poured and columns, slabs or ceilings are cast, the free ends of the strap, that do not carry the loops or the rings, are embedded into the concrete. The process is typically repeated every 30-40 feet and the concrete is allowed to set. Once the concrete has hardened, the worker is able to tie-off from it. Such straps can also be installed by looping the straps around a piece of rebar, then inserting them into the poured concrete. Such straps are useful in areas that don't have cable rails or handrails. Once the work has been completed, the exposed portion of the straps are cut and removed. However, as with numerous other prior art safety devices, there is a limitation on the freedom of movement of the worker, since the worker is essentially tethered to a relatively short length of strap.

### SUMMARY OF THE INVENTION

Accordingly, it is an object of the invention to provide a safety system for use with fall prevention at construction sites that does not have the disadvantages inherent in the prior proposed devices and systems.

It is another object of the invention to provide a safety hanger system that provides requisite safety at construction sites while maximizing the flexibility and range of movements of construction workers at the site.

It is still another object of the invention to provide a safety hanger system that easy to install.

It is yet another object of the invention to provide a safety hanger system for construction sites that provides safety not only to individual tethered workers but to all workers that operate within a given zone or perimeter.

It is a further object of the invention to provide a construction safety system that satisfies and complies with OSHA regulations.

It is still a further object of the invention to provide a method of installing and using the safety hanger system as described in the previous objects.

It is yet a further object of the invention to provide a safety hanger that can be re-used and need not be destroyed after use.

It is an additional object of the invention to provide a safety strap and system using the same that provides optimal safety to workers that is inexpensive to produce and cost efficient.

In order to achieve the above objects, and others that will become evident hereinafter, the safety hanger system in accordance with the present invention includes the use of a plurality of safety hanger straps, each of which is provided with opposing closed loop ends. A metal or other rigid ring is linked through one of the loops at one end of the strap. At least one or, preferably, two snap hooks are supported on the ring. In use, the strap is wrapped about a horizontal member of a stringer or other support member forming a subfloor prior to a permanent floor being constructed on the subfloor. After the safety hanger is wrapped about a horizontal member of the subfloor, the end of the strap that supports the loop and the snap hooks is passed trough the loop of a strap at the other end to form the equivalent of a slip knot or running knot so that when the strap is attached to a fixed support member and tension is applied to the free end of the strap to which the ring and snap hooks are connected, the strap is tightened and secured to the support member. By securing a plurality of such safety hangers along the horizontal stringers, a safety net can be secured to the snap hooks so that safety nets can be provided below adjacent stringers to catch any worker that slips through the subfloor under which the net is placed. This gives workers a complete freedom of movement above the subfloor without the need for the workers to be tethered by lanyards or straps to any given fixed point. With the invention, the region under which the safety nets are mounted is not limited and the zones for such safety net protection can be limited to a given small zone or region or the entire subfloor by securing a plurality of nets in the manner described.

### BRIEF DESCRIPTION OF THE DRAWINGS

Those skilled in the art will also appreciate the improvements and advantages that derive from the present invention upon reading the following detailed description, claims, and drawings.

FIG. 1 is a perspective fragmented view of a safety hanger in accordance with the present invention, shown wrapped about a lower horizontal member of a stringer forming a subfloor of a yet unfinished floor structure and indicating the manner in which the snap rings are connected to a safety net; and

FIG. 2 is a perspective view of a construction site in which a plurality of stringers are supported by support posts and a plurality of safety nets are supported by the stringers by means of the safety hangers in accordance with the present invention.

### DESCRIPTION OF THE PREFERRED EMBODIMENTS

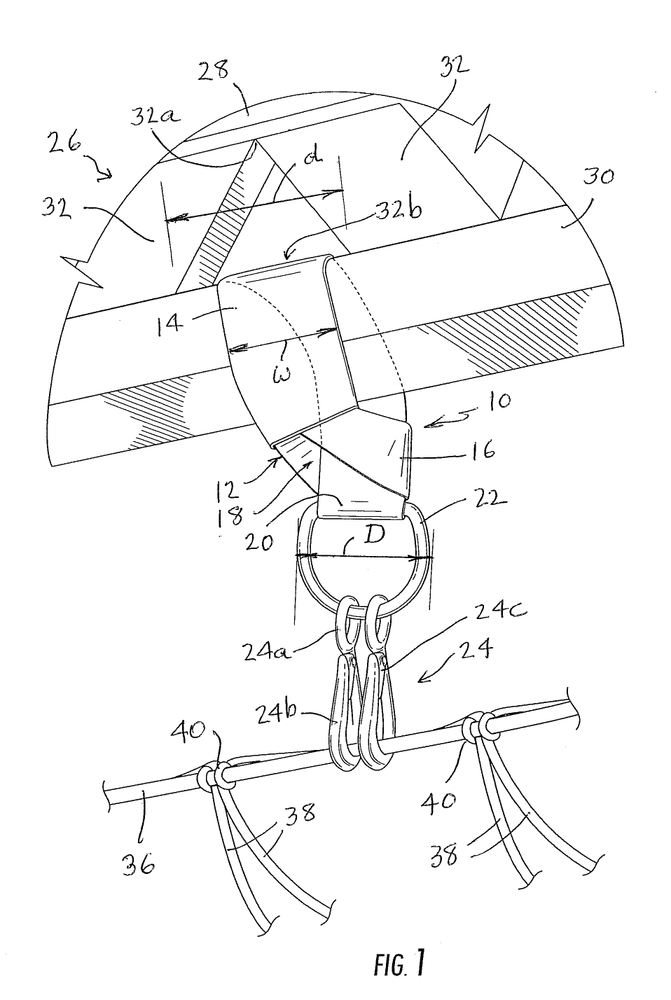

Referring now specifically to the Figures, in which the identical or similar parts are designated by the same numeral numbers throughout, and first referring to FIG. 1, a safety hanger in accordance with the present invention is generally designated by the reference numeral 10.

The hanger 10 is in a nature of strap 12 made, for example, of highly durable nylon. However, other strong suitable materials can be used. Optionally, a protective sleeve 14 is provided to cover the strap while exposing the free ends thereof. The protective sleeve 14 provides a low friction interface between the strap and the support member on which it is mounted to ensure that the strap can be readily tightened without creating significant friction between the strap and support member. The strap 12 is provided with two ends, one free end 16 being provided with a closed loop that forms an opening 18. The other end 20 of the strap is likewise provided with a closed loop end for capturing a D-ring or any of the suitable metallic or rigid ring member. While a D-ring 22 is presently preferred, other shapes or configurations, such a triangular ring may also be used. Numerous other methods of securing the rings to the strap 12 are available and will become readily evident to those skilled in the art. By way of examples only, a threaded shackle or any one of a number of different styled shackles or a carabiner may be used with or without a ring. Also, it is possible to use a continuous ring (without split) to strengthen the ring, in which case rings or links that can be selectively opened and closed can be used to attach the snap hooks to a non-split ring extending through the end 20 of the strap.

Captured on the D-ring 22 are at least snap hook 24, two such snap hooks being shown in FIG. 1. Each snap hook includes an eyelet 24a through which the ring 22 passes. A hook 22b may be a conventional hook that cooperates with snap 24c. Such snap hooks are well known and the snaps 24c are typically spring biased to maintain the hook closed but may be opened by application of suitable force to the snaps sufficient overcome the spring biasing forces.

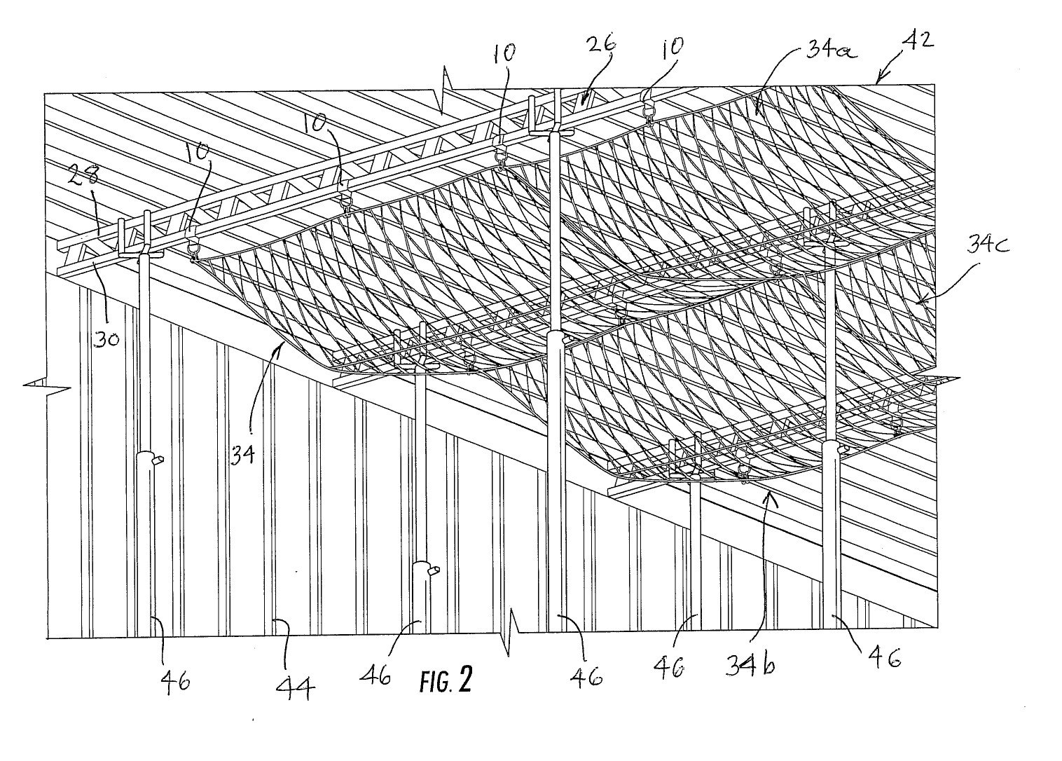

Also shown in FIG. 1 is a section of a stringer 26 of a type commonly used in the construction trades for constructing a subfloor and, ultimately, a finished floor. The stringer 26 may be, for example, a girder marketed by Peri GmbH of Weissenhorn, Germany and consists of an upper horizontal member 28 and lower horizontal member 30. Angular connecting members 32 alternate in inclination as shown to produce a series of, openings, each in the shape of a triangle that alternate 180° as to the orientations. Each triangle includes a point of minimum width, at points 32a, and of greatest width at base 32b. The width of each base 32b is shown to be “d”, while the strap and sleeve have a width “w” which is less than “d” so that the strap can readily pass through alternate openings or at any spacing through such openings as may be desired or required for optimizing safety. Referring to FIG. 2 such hangers are shown spaced along each stringer through each third opening, but this is not critical for purposes of the invention. Clearly, the closer the safety hangers are spaced, the more support and more safety that the resulting system provides.

After the safety hangers 10 are mounted on the stringers as shown in FIGS. 1 and 2, a safety net 34 can be suspended from the safety hangers. The net 34 includes peripheral line 36 to which a network of filaments 38 are secured by means of knots 40 in accordance with well known technique for creating such nets. Any conventional safety nets approved for such safety purposes can be used.

Referring to FIG. 2, a building structure 42 is shown that includes a plurality of vertical framing studs 44. Adjustable support posts 46 are used to support level a plurality of horizontal stringers 26 that are horizontally spaced from each other along the building structure. A plurality of substantially equally spaced ribs 48 are spaced along and supported by the stringers 26 in accordance with well known construction techniques. It is at this stage of the construction that a more permanent subfloor and finished floor are created above the stringers. Typically, plywood is laid on the ribs and ultimately a concrete floor is poured. It is during this construction phase that workers work along and are supported by the ribs 48. However, with the safety net as described a worker that slips and falls through the ribs is immediately caught by the safety net 34. As suggested, by applying the safety hangers 10 along successive stringers a plurality of nets 34, 34a, 34b and 34c can be suspended and thereby increase the overall safety zone. If desired such safety hangers and nets can be suspended below the entire subfloor or under only a portion of the subfloor if only a given zone or region is to be worked on any given time.

The method of the present invention involves securing the plurality of safety hangers of the type described spaced from each other along stringers and, thereafter attaching a safety net by means of the snap hooks 24. It will be appreciated that with the safety hangers in accordance with the present invention and with the safety system created thereby using the safety nets, the workers are permitted to walk freely along the entire region or zone within the perimeter forming the safety net without the need to be tethered to a given point thereby limiting their mobility to a limited radius of movement.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What claimed is:

1. A safety hanger system for attachment to horizontal members of stringers or other support members forming a subfloor comprising:
plurality of safety hanger straps each of which is provided with closed loop ends;
a rigid retaining member linked through one of said loop ends at one end of each of said straps;
at least one disengageable fastener supported on each retaining member;
said plurality of safety hangers being attachable in spaced relationship to the horizontal members or stringers with said at least one fastener positioned to engage a safety net to support said safety net below the adjacent horizontal members of stringers or support members to catch a worker that slips through a subfloor under which the net is placed, whereby workers have freedom of movement above the subfloor without the need to be tethered by lanyards or straps to any given fixed point.

2. A safety hanger system as defined in claim 1, further comprising a protective sleeve that covers each strap while exposing said free ends to provide a low friction interface between the straps and the support members on which they are mounted to allow the straps to be tightened in a slip knot fashion without creating significant friction.

3. A safety hanger system as defined in claim 1, wherein said retaining members are closed rings.

4. A safety hanger system as defined in claim 3, wherein said rings are D-rings.

5. A safety hanger system as defined in claim 3, wherein said rings are made of a rigid metal.

6. A safety hanger system as defined in claim 3, wherein said rings are triangular in shape.

7. A safety hanger system as defined in claim 1, wherein said fasteners are snap hooks.

8. A safety hanger system as defined in claim 1, wherein said fasteners are shackles.

9. A safety hanger system as defined in claim 1, wherein said fasteners are carabiners.

10. A safety hanger system as defined in claim 1, wherein two disengageable fasteners are secured to each rigid retaining member.

11. A safety hanger system as defined in claim 1, wherein said disengageable fasteners are spring biased to allow attachment to a retaining member and to automatically maintain such attachment until manual force is applied to disengage the same by overcoming the biasing force.

12. A safety hanger system as defined in claim 1, in combination with a safety net.

13. A method of providing safety hanger system for attachment to horizontal members of stringers or other support members forming a subfloor comprising:
providing plurality of safety hanger straps each of which is provided with closed loop ends with rigid retaining members linked through one of said loop ends at one end of each of said straps and at least one disengageable fastener supported on each retaining member;
securing said plurality of safety hangers in spaced relationship to the horizontal members or stringers by wrapping each safety hanger strap around an associated stringer or other support member and extending the closed loop end with a rigid retaining member through the closed loop at the other end to create a slip knot that can be tightened while exposing said at least one disengageable fastener on each strap; and
attaching said fasteners to a safety net to support said safety net below the adjacent horizontal members of stringers or support members to catch a worker that slips through a subfloor under which the net is placed, whereby workers have freedom of movement above the subfloor without the need to be tethered by lanyards or straps to any given fixed point.

14. A method as defined in claim 13, further comprising applying safety hanger straps along successive stringer arranged to attach to a plurality of nets to increase an overall safety zone.

15. A method as defined in claim 14, wherein safety hanger straps and safety nets are suspended under only a portion of a subfloor.

16. A method as defined in claim 14, wherein safety hanger straps and safety nets are suspended below an entire subfloor.
